(19) United States
(12) Patent Application Publication
(10) Pub. No.: US 2023/0138694 A1
(43) Pub. Date: May 4, 2023

(54) Material Shaping Method and Shaped Products

(71) Applicant: Lexur Limited, Hamilton (NZ)

(72) Inventor: Felix Hugo Wells, Hamilton (NZ)

(73) Assignee: Lexur Limited, Hamilton (NZ)

(21) Appl. No.: 17/917,793

(22) PCT Filed: Apr. 8, 2021
(86) PCT No.: PCT/NZ2021/050060

§ 371 Date: Oct. 7, 2022

(30) Foreign Application Priority Data
Apr. 8, 2020 (NZ) 763347

(51) Int. Cl. B29C 67/20; C08J 9/26

(52) U.S. Cl. CPC B29C 67/202; C08J 9/26; B29K 2075/00

(57) ABSTRACT

The present invention relates to a method of shaping material having a plurality of interstices (such as a network of voids) and shaped products formed by the method. In preferred embodiments the material is a foam such as a polyurethane foam. The shaping method allows such materials to be shaped using contour-shaping machining methods including computer numerical control (CNC) milling, which is provided by way of example only. To be contrasted with methods of manufacturing a shaped material (such as by the polymerisation of a solution or emulsion of monomers), in several aspects the present invention contemplates the shaping of existing (preformed) materials having a plurality of interstices, such as a network of voids.

### FIELD OF INVENTION

The present invention relates to a method of shaping material having a plurality of interstices (such as a network of voids) and shaped products formed by the method. In preferred embodiments the material is a foam such as a polyurethane foam. The shaping method allows such materials to be shaped using contour-shaping machining methods including computer numerical control (CNC) milling, which is provided by way of example only. To be contrasted with methods of manufacturing a shaped material (such as by the polymerisation of a solution or emulsion of monomers), in several aspects the present invention contemplates the shaping of existing (preformed) materials having a plurality of interstices, such as a network of voids.

### BACKGROUND OF THE INVENTION

Flexible foam fabrication is the means by which foams are shaped for a desired end result by shaping of foam stock or casting of resin systems (excluding the casting for mass produced foam stock intended for fabrication). Shaping methods include: hand shaping; and computer numerical controlled shaping, examples being, CNC mills, lathes, turn-mills and multi-axial mechanical arm shaping

Materials such as polyurethane foam are notoriously difficult to shape with precision. Whilst it is relatively easy to cut such foams with blades, saws, and the like, attempting to contour shape such foams using conventional machining methods (such as computer numerical control (CNC) methods) leads to imprecise contours and generally undesirable machining finishes. In particular, the present inventor believes that the inferior finish is caused by deformation of the foam by the machining tool during the shaping process, leading to the material cutting, or even tearing, at an imprecise location. Rather than generating a smooth surface, such machining generates a rough surface.

Despite this challenge, shaped polyurethane foam is widely used in padding in seats, packaging, etc. Often the user desires a precisely shaped polyurethane product for such applications as wheelchair seating where a bespoke shaped product is desired.

There have been very few attempts to overcome the problems described herein. Broadly, the methods that have been previously employed may be categorised as:

Cryogenic processes. This method of machining is relatively fast, accurate and achieves desirable results at the expense of higher equipment costs (which must be able to tolerate extreme temperatures), handling, storage and excessive usage of liquefied gaseous coolants along with exposure to fine foam dust and the hazards of liquefied gasses;

Liquid freezing. This method involves saturating the foam with water before freezing the water in situ. Freezing is a simplified version of the cryogenic process that allows for lower comparable costs to cryogenic and dry machining by allowing a sufficiently low temperature to be maintained using frozen water. However this process requires the water to remain frozen (can be aided by cooling the foam and water) during all stages of the shaping process for optimal results. The expansion of water, as it solidifies, results in micro-fracturing of the foam. Still further the freezing of water actually leads to suboptimal machining quality and precision as the machining tolerances can be unpredictably disturbed by the expansion of the water within the foam with reduced temperature, coupled with the loss of melting ice around the shaping surface when a high speed/friction machining tool contacts the surface. Another problem with this method is that the water needs to be contained and the machine components must be compatible with water so as to avoid corrosion, electrical failures and spillage; and

Dry machining. This method refers to techniques other than cryogenic and liquid freezing described above and requires extended machining times, high-end equipment and tooling, and exposes technicians to hazardous dust whilst only providing limited geometry.

Due to the limitations of these methods, not least of which is the health hazard of generating fine particulates, traditional hand shaping methods remain extensively employed in the fabrication of foams.

Apart from flexible foam shaping, it is often desired to shape porous metal materials which are typically inflexible. Such materials suffer from different issues as compared to flexible foams. For example, machining of porous metal materials produces burrs which vary in size and shape depending, in part, on the temperature and material used. At high temperatures the cutting tool and point of contact with the metal becomes softer leading to the tendency for metals to plastically displace to form smears or burrs. Such temperatures also accelerate the dulling of machining tools. To overcome those problems, it is possible to apply a coolant so that the temperature of the material is lowered to harden the metal so as to produce cleaner cuts and prevent burrs, smears and associated damage. Further teachings in the area of porous metal machining clarifies the problem as being a result of ductile shear and the solution to smear is primarily dependent on achieving a “brittle shear” using cryogenic methods.

Just as in all methods of machining, in the previously mentioned methods it is necessary to ensure that the material to be shaped is held securely during the shaping process. Traditionally the material is clamped or otherwise fastened such as by the use of an adhesive, such as cyanoacrylate or similar “super-glue” adhesives. Such techniques typically damage the material due to the direct mechanical action of the clamps or as a result of the excess of force required to break the bond with the adhesive.

It is an aim of the present invention to address one or more of the foregoing problems or at least provide the skilled addressee with a useful choice.

### SUMMARY OF THE INVENTION

In a first aspect the invention provides a method of shaping an elastic or viscoelastic material having a plurality of interstices, the method including the steps of:

i. providing an elastic or viscoelastic material having a plurality of interstices;

ii. contacting the material with an additive so that at least a portion of the additive is incorporated within at least a portion of the plurality of interstices of the material;

iii. subjecting the material to conditions so that at least a portion of the incorporated additive solidifies, hardens, and/or stiffens;

iv. shaping the material incorporating the solid, hard, and/or stiff additive so as to form a shaped material incorporating the additive; and

v. removing at least a portion of the incorporated additive from the shaped material incorporating the additive,

wherein the additive solidifies, hardens, and/or stiffens at a temperature of greater than 0° C.

In some embodiments the elastic or viscoelastic material having a plurality of interstices is an elastic or viscoelastic material having a network of voids.

Accordingly, in a second aspect the invention provides a method of shaping an elastic or viscoelastic material having a network of voids, the method including the steps of:

i. providing an elastic or viscoelastic material having a network of voids;

ii. contacting the material with an additive so that at least a portion of the additive is incorporated within at least a portion of the network of voids of the material;

iii. subjecting the material to conditions so that at least a portion of the incorporated additive solidifies, hardens, and/or stiffens;

iv. shaping the material incorporating the solid, hard, and/or stiff additive so as to form a shaped material incorporating the additive; and

v. removing at least a portion of the incorporated additive from the shaped material incorporating the additive,

wherein the additive solidifies, hardens, and/or stiffens at a temperature of greater than 0° C.

The method of the present invention allows for the production of a shaped elastic or viscoelastic material having a desirable surface finish. The method makes use of an additive that solidifies, hardens and/or stiffens at a temperature above the freezing point of water (0° C. at standard atmospheric pressure, 101.325 kPa). The additive is incorporated within the material so that the material can be shaped while the additive is solidified, hardened and/or stiffened so as to prevent undesirable deformation of the material as it is being shaped.

By way of example only, in some embodiments the additive is a wax and the elastic or viscoelastic material having a plurality of interstices (such as a network of voids) is a polyurethane foam. In those embodiments the method can involve incorporating molten wax within the material which, upon cooling to room temperature, solidifies and the foam may then be shaped by CNC milling. At least some of the wax is then removed from the shaped foam.

Without wishing to be bound by theory it is believed that the present methods allow for the material to be shaped without substantially altering the elastic modulus of the material itself. Moreover an additive may be selected such that the difference in temperature between the additive being liquid and solid may be limited so that contraction of the material, if any, is very limited. Still further, by judicious modulation of the amount of additive that is incorporated within the material, it is possible to avoid saturation of the material thereby providing greater control over potential expansion or shrinkage.

It is further believed that whereas the prior published approaches of cryogenics weaken and impair the structure of the foam material at a molecular level to achieve machining, the present invention creates a mechanical advantage to the benefit of the machining tool by focusing a shear force between the high inertia of the immobilising additive (particularly wax) relative to the high momentum of the rotating cutting edge of the tool.

As such the present invention represents a significant advance over the prior published methods since it allows for the shaping of elastic or viscoelastic materials at room temperature and a range of other temperatures above the freezing point of water. The advantages of the present invention are compounded by the self-healing characteristics of the additive used in some embodiments—for instance any additive (such as wax) that is temporarily melted by the machining tool subsequently hardens after the tool has moved passed, thereby once again contributing to the rigidity of the material. The use of a wax based additive can also lubricate the machine and the cutting tool for increased service life, and may do so while reducing the risk of electrical failure otherwise possible when using water in the prior published liquid freezing methods.

In a third aspect the invention provides a shaped elastic or viscoelastic material having a plurality of interstices (such as a network of voids) prepared by the method of the first or second aspects.

In a fourth aspect the invention provides the use of an additive which is solid, hard and/or stiff at a temperature of greater than 0° C. to shape an elastic or viscoelastic material having a plurality of interstices (such as a network of voids) within which the additive has been incorporated.

In a fifth aspect the invention provides a contoured elastic or viscoelastic material having a plurality of interstices (such as a network of voids), wherein at least a portion of the material has an additive incorporated in the material, wherein the additive is solid, hard and/or stiff at a temperature of greater than 0° C.

As used herein the term “contoured” refers to the form of an article that has been subject to the techniques of contouring, contour machining, 3D machining, or 3D contour machining.

In a sixth aspect the invention provides a method of shaping an elastic or viscoelastic material having a plurality of interstices, the method including the steps of:

i. providing an elastic or viscoelastic material having a plurality of interstices;

ii. contacting the material with an additive so that at least a portion of the additive is incorporated within at least a portion of the plurality of interstices of the material;

iii. subjecting the material to conditions so that at least a portion of the incorporated additive solidifies, hardens, and/or stiffens;

iv. shaping the material incorporating the solid, hard, and/or stiff additive so as to form a shaped material incorporating the additive; and

v. removing at least a portion of the incorporated additive from the shaped material incorporating the additive,

wherein the additive is not water and the additive solidifies, hardens, and/or stiffens when subject to changes in conditions selected from: thermal, magnetic, electrical, chemical, and/or electromagnetic.

In a seventh aspect the invention provides a method of shaping an elastic or viscoelastic material having a network of voids, the method including the steps of:

i. providing an elastic or viscoelastic material having a network of voids;

ii. contacting the material with an additive so that at least a portion of the additive is incorporated within at least a portion of the network of voids of the material;

iii. subjecting the material to conditions so that at least a portion of the incorporated additive solidifies, hardens, and/or stiffens;

iv. shaping the material incorporating the solid, hard, and/or stiff additive so as to form a shaped material incorporating the additive; and

v. removing at least a portion of the incorporated additive from the shaped material incorporating the additive,

wherein the additive is not water and the additive solidifies, hardens, and/or stiffens when subject to changes in conditions selected from: thermal, magnetic, electrical, chemical, and/or electromagnetic.

In some embodiments the elastic or viscoelastic material having a plurality of interstices is an elastic or viscoelastic material having a network of voids.

In an eighth aspect the invention provides a method of shaping an elastic or viscoelastic material having a network of voids, the method including the steps of:

i. providing an elastic or viscoelastic material having a network of voids;

ii. contacting the material with an additive so that at least a portion of the additive is incorporated within at least a portion of the network of voids of the material;

iii. subjecting the material to conditions so that at least a portion of the incorporated additive solidifies, hardens, and/or stiffens;

iv. shaping the material incorporating the solid, hard, and/or stiff additive so as to form a shaped material incorporating the additive; and

v. removing at least a portion of the incorporated additive from the shaped material incorporating the additive,

wherein the additive solidifies, hardens, and/or stiffens when subject to changes in conditions selected from: magnetic, electrical, chemical, and/or electromagnetic.

In a ninth aspect the invention provides a shaped elastic or viscoelastic material having a plurality of interstices (such as a network of voids) prepared by the method of the fifth aspect or the sixth aspect.

In a tenth aspect the invention provides the use of an additive to shape an elastic or viscoelastic material having a plurality of interstices (such as a network of voids) within which the additive has been incorporated, wherein the additive solidifies, hardens, and/or stiffens when subject to changes in conditions selected from: magnetic, electrical, chemical, and/or electromagnetic.

In an eleventh aspect the invention provides a contoured elastic or viscoelastic material having a plurality of interstices (such as a network of voids), wherein at least a portion of the material has an additive incorporated in the material, wherein the additive solidifies, hardens, and/or stiffens when subject to changes in conditions selected from: magnetic, electrical, chemical, and/or electromagnetic.

In a twelfth aspect the invention provides a method of forming a shaped elastic or viscoelastic material having a plurality of interstices, the method including the steps of:

i. in a vessel contacting an additive with a resin capable of being cured to form an elastic or viscoelastic material to form a mixture;

ii. degassing the mixture, such as by vacuum, and/or mixing the mixture to form a homogeneous blend;

iii. curing the resin so as to form an elastic or viscoelastic material incorporating at least some of the additive;

iv. shaping the material incorporating the additive so as to form a shaped material incorporating the additive; and

v. optionally removing at least a portion of the incorporated additive from the shaped material incorporating the additive,

wherein the additive is not water and the additive solidifies, hardens, and/or stiffens when subject to changes in conditions selected from: thermal, magnetic, electrical, chemical, and/or electromagnetic.

In a thirteenth aspect the invention provides a method of forming a shaped elastic or viscoelastic material having a network of voids, the method including the steps of:

i. in a vessel contacting an additive with a resin capable of being cured to form an elastic or viscoelastic material to form a mixture;

ii. degassing the mixture, such as by vacuum, and/or mixing the mixture to form a homogeneous blend;

iii. curing the resin so as to form an elastic or viscoelastic material incorporating at least some of the additive;

iv. shaping the material incorporating the additive so as to form a shaped material incorporating the additive; and

v. optionally removing at least a portion of the incorporated additive from the shaped material incorporating the additive,

wherein the additive is not water and the additive solidifies, hardens, and/or stiffens when subject to changes in conditions selected from: thermal, magnetic, electrical, chemical, and/or electromagnetic.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

One or more embodiments of the invention will be described below by way of example only, and without intending to be limiting, with reference to the following drawings, in which:

FIG. 1 shows a schematic flowchart for the process of incorporating a wax additive in a foam material and securing that material to a machining surface;

FIG. 2 shows a schematic flowchart for the process of single or two sided machining of a foam material incorporating wax;

FIG. 3 shows a schematic flowchart for the process of removing at least a portion of the incorporated wax additive from a foam material;

FIG. 4 shows a schematic flowchart for the methods of the invention being applied to a multitude of shaped stock;

FIG. 5 shows a schematic flowchart for a method of the invention where a solid additive is used to generate a shaped article;

FIG. 6 shows a schematic flowchart for multiple embodiments of the method of the invention including the step of contacting a foam with an additive;

FIG. 7 shows a schematic flowchart for the use of a vessel as a mould;

FIG. 8 shows a schematic flowchart for a process using solid granules, powders etc and other additives. Optionally these can be manipulated by external stimuli—being solid or otherwise;

FIG. 9 shows a schematic flowchart for a process wherein the addition or removal of heat can be used to modify the properties of the additive;

FIG. 10 shows a schematic flowchart for a continuation process for that shown in FIG. 9;

FIG. 11 shows a schematic flowchart for a process for the removal of the additive.

FIGS. 12 and 13 show a schematic flowchart for a process wherein a mould is used to create an impression in a foam before CNC machining.

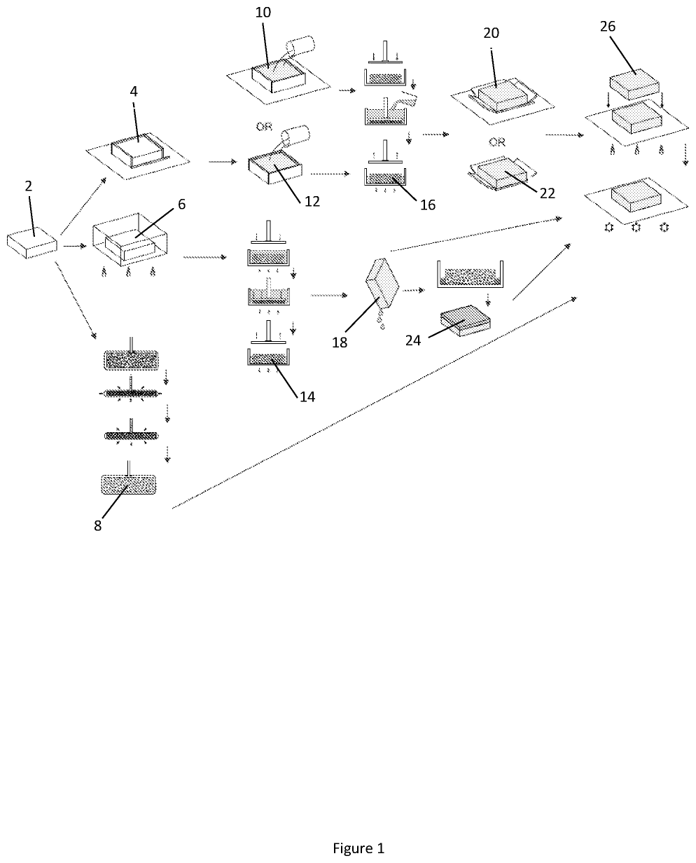

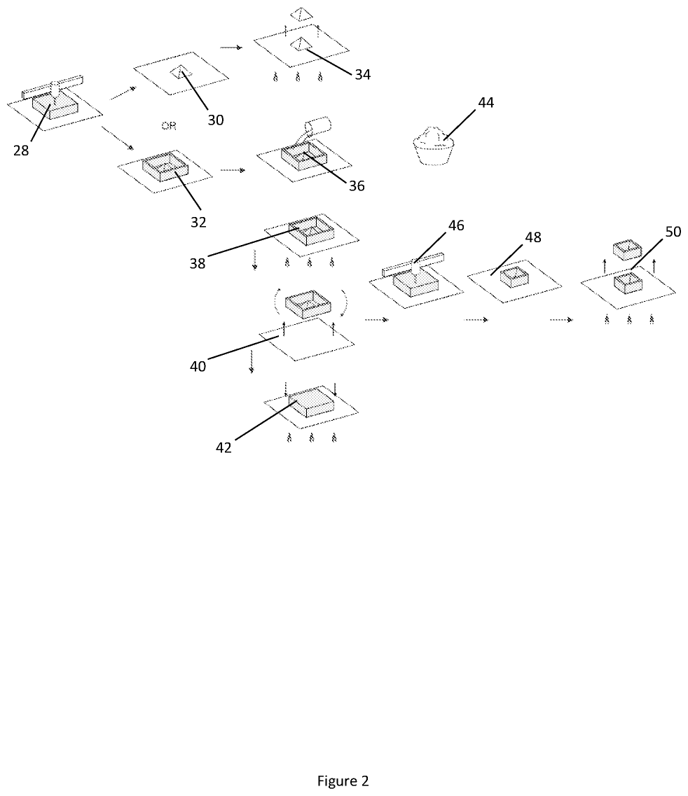

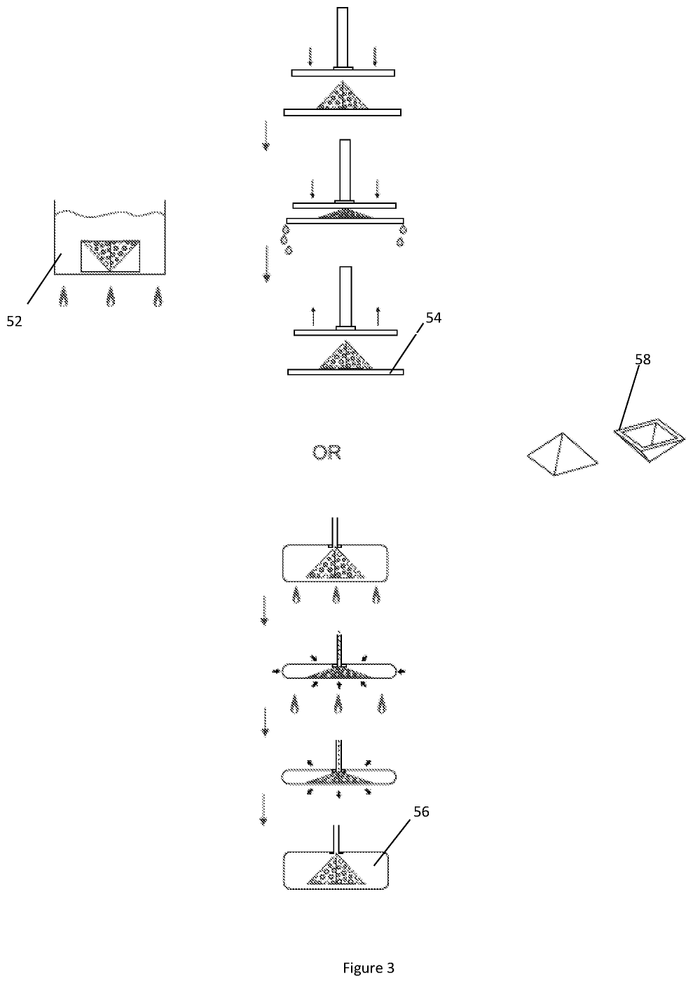

The figures do not necessarily represent the order of operation or any association between the steps on the page.

A foam is used by way of example only for illustrative purposes.

A vacuum bag is only intended to demonstrate by example. A vacuum bag could be arranged in other suitable arrangements such as sealing a suitable sheet to a solid plate or as a flexible gusset affixed between two solid plates to enable the sheets to come together when under vacuum. The plates could have one or more inlets/outlets as distinct openings or valves; or a plurality of openings or valves that could converge by way of a manifold.

A press could be mechanical or by hand; or manipulated by hands; or a combination of a bag arrangement as described above that is compressed mechanically or by hand.

### DETAILED DESCRIPTION OF THE INVENTION

As used herein the expression “elastic or viscoelastic” material refers to a class of materials that is:

i. deformably resilient (elastic); or

ii. substantially deformably resilient such that some energy is dissipated through the process of deforming from a first position to a second position and returning substantially to the first position (viscoelastic).

The material of the invention includes a matrix of solid material within which is a plurality of interstices, such as a network of voids. Examples of interstices are: cells having incomplete wall region(s); tunnels; channels; holes; void platelets; interstitial spaces; etc. The interstices may be in fluidic communication so that an additive can penetrate into the material, such as through a network of voids. The interstices may be arranged in an array of interstices such as in a honeycomb material. Such interstices may or may not be in fluidic communication with one or more other interstices. Nonetheless such interstices are capable of having additive added to them and/or removed from them. Preferably such interstices will be capable of having additive added to them and removed from them.

As such, materials of the invention are to be distinguished from materials which:

are not capable of having additive added to them and/or

are not capable of having additive removed from them and/or

do not contain a network of voids that are in fluidic communication, and typically contain a significant number of discrete cells of gas.

By way of example only, open-celled foam is an elastic or viscoelastic material having a network of voids and is capable of being used in the methods of the invention, whereas closed-cell foam is not an elastic or viscoelastic material having a network of voids capable of being used in the methods of the invention.

As used herein “interstice” refers to a space within the material that may, for example, be filled with gas, liquid, or some other material other than the elastic or viscoelastic material. Interstices are generally small spaces, but nonetheless capable of for example, being filled with gas, liquid, or some other material other than the elastic or viscoelastic material. The interstices may be regularly shaped or irregularly shaped. The interstices may be the same size or different sizes. For example, in a foam, the interstices will generally consist of a range of differently sized spaces. The size of any given interstice may be measured in a number of ways, including minimum, maximum, or average linear dimension. It may be convenient to measure the size of the interstice(s) by average linear dimension across 2 or more axes, such as 2 orthogonal axes. The lowest limit of size will typically be limited only by the ability of a gas, liquid, or some other material other than the elastic or viscoelastic material to penetrate into at least a portion of the interstice(s). The largest limit of size will typically be unlimited, although interstices having average linear dimensions of the order of up to about 1000 mm, such as up to about 500 mm, such as up to about 300 mm, such as up to about 100 mm, such as up to about 50 mm, such as up to about 25 mm, such as up to about 10 mm, such as up to about 5 mm, such as up to about 2 mm, such as up to about 1 mm will be preferred. In some embodiments the interstices will be of the order of at least 0.001 mm in size, such as at least 0.01 mm in size, such as at least 0.1 mm in size. It will be understood that a number of techniques may be used to form materials having a plurality of interstices, such as emulsion polymerisation of a polyurethane. Such techniques will generally produce a material having interstices having a distribution of sizes. As such, in some embodiments the dimension limits described herein will apply to at least 60% of the interstices, such as at least 70% of the interstices, such as at least 80% of interstices, such as at least 90% of the interstices, such as at least 95% of the interstices. In some embodiments the dimensions limits described herein will apply to 100% of the interstices.

As used herein, plurality means two or more. It will generally be the case that the elastic or viscoelastic material has not only a plurality of interstices, but at least several (3) interstices, such as a multitude of interstices. The elastic or viscoelastic material may have at least 5, such as at least 10, such as at least 20, such as at least 50, such as at least 100, such as at least 500, such as at least 1000, interstices.

As used herein “void” refers to a space within the material that may, for example, be filled with gas, liquid, or some other material other than the elastic or viscoelastic material. Voids are generally small spaces, but nonetheless capable of for example, being filled with gas, liquid, or some other material other than the elastic or viscoelastic material. The voids may be regularly shaped or irregularly shaped. The voids may be the same size or different sizes. For example, in a foam, the voids will generally consist of a range of differently sized spaces. The size of any given void may be measured in a number of ways, including minimum, maximum, or average linear dimension. It may be convenient to measure the size of the void(s) by average linear dimension across 2 or more axes, such as 2 orthogonal axes. The lowest limit of size will typically be limited only by the ability of a gas, liquid, or some other material other than the elastic or viscoelastic material to penetrate into at least a portion of the void(s). The largest limit of size will typically be unlimited, although voids having average linear dimensions of the order of up to about 1000 mm, such as up to about 500 mm, such as up to about 300 mm, such as up to about 100 mm, such as up to about 50 mm, such as up to about 25 mm, such as up to about 10 mm, such as up to about 5 mm, such as up to about 2 mm, such as up to about 1 mm will be preferred. In some embodiments the interstices will be of the order of at least 0.001 mm in size, such as at least 0.01 mm in size, such as at least 0.1 mm in size. It will be understood that a number of techniques may be used to form materials having a network of voids, such as emulsion polymerisation of a polyurethane. Such techniques will generally produce a material having voids having a distribution of sizes. As such, in some embodiments the dimension limits described herein will apply to at least 60% of the voids, such as at least 70% of the voids, such as at least 80% of voids, such as at least 90% of the voids, such as at least 95% of the voids. In some embodiments the dimensions limits described herein will apply to 100% of the voids.

It will be understood that not all of the voids in the material of the invention are necessarily in fluidic communication with each other. It is sufficient for the present invention that a significant number (such as at least 10%, at least 20%, at least 30%, at least 40%, at least 50%, at least 60%, at least 70%, at least 80%, at least 90%) are in fluidic communication with each other. As such, the term “network of voids” as used herein refers to a significant number (such as at least 10%) of the voids being in fluidic communication with each other. Typically at least 50% (such as at least 60%, at least 70%, at least 80%, at least 90%) of the voids are in fluidic communication with each other.

One example of a material having a plurality of interstices, wherein each of the interstices are not necessarily interconnected cells but are otherwise functionally the same as more extensively networked voided materials described immediately above, is a flexible elongated honeycomb material which is open-celled but wherein an additive would not readily (or at all) pass from cell to cell. This is a common material and can be used as a substitute for regular flexible polyurethane foams. Another example could be gill-like or resemble a soft flexible heatsink, such that it includes a multitude of elongate members (such as plates, vanes or rods). In such an example the material may have voids (between the elongate members) but without substantial interconnection between the voids.

Other such materials of the invention having a plurality of interstices could be described as brush-like in appearance where the material has parallel or linear filaments (and may be fixed at one end or both ends). For example, a material with the appearance of a dense silicone brush could be shaped using the disclosed invention. The purpose of this could be for prototyping or producing a small production of contoured brushes, or various vibration dampening and cushioning systems.

It will be understood that the present invention is predicated, in part, on the ability of the additive to penetrate into the material through the interstices, such as voids. As such, the interstices (such as voids) are limited in dimension and other properties (including the chemical and/or physical properties of the surrounding matrix of material) only by the requirement that the additive can penetrate into the material through the the interstices, such as voids, to a degree sufficient to enable the method of the invention to be performed.

Materials having a plurality of interstices (such as a network of voids) can be formed in a multitude of ways, including in some embodiments by incorporating an inflating agent, such as sodium bicarbonate, into a material so that the agent gives off a gas when the material is subject to certain conditions, such as heating. Examples of such materials having a plurality of interstices (such as a network of voids)include foams, felts, lattices, scaffolds, coiled materials, meshes, and webs. Preferably the material of the present invention is a foam, and it is convenient (for illustrative purposes only) to describe the invention with respect to foams, although it will be understood that the general principle described herein may be applied to all elastic or viscoelastic materials having a plurality of interstices (such as a network of voids). Foams may be at least partially, if not completely, formed from a polymer that is natural or synthetic.

It will be understood that there are many known materials having a plurality of interstices (such as a network of voids) that are neither elastic nor viscoelastic. Such materials include: ceramic foams; metallic foams; rigid foams (eg expanded polystyrene (EPS) and extruded polystyrene (XPS)); and rigid grades of foams (eg rigid polyurethane (PU), rigid melamine foam). Such materials are not contemplated by the present invention, for the reasons discussed below, including that the methods of the present invention can advantageously make use of the elastic or viscoelastic properties of the material to incorporate the additive. Without those properties the incorporation of the additive, and subsequent removal, is more difficult to achieve.

It will be appreciated that the material should preferably be selected to be substantially resistant to the physical and/or chemical conditions under which it is subject in the method of the invention.

As used herein the term “additive” refers to a component that is distinct from the elastic or viscoelastic material and which can be incorporated within at least a portion of the plurality of interstices (such as a network of voids) of the material. Examples of additives include:

wax or wax-like compounds and mixtures thereof. The wax may preferably be water insoluble. The wax-like compound may be water soluble such as PEGs, panthenol, waxlike emulsifiers and their mixtures;

crystalline solid/supersaturated liquid (eg a supersaturated solution which is stable at room temperature (eg sodium acetate trihydrate or similar); a supersaturated solution which is not stable at room temperature but requires less heat to remain liquid than, for example pure molten sucrose; crystalline materials in a molten state (such as sucrose) which crystallises upon cooling (this example may also include one or more modifiers to lower the melting point)). Salts and sugar alcohols may be used. Eutectics of sugar alcohols and other mixtures are also capable of utility;

liquid crystallising compounds (eg electrically active liquid that would self-assemble to form a stiffer material and provide some resistance such as an electrically active material consisting of a solution containing an amphiphilic mesogen that could gel or stiffen in response to an electrical stimulus and may be reversible if not water soluble for removal);

non-Newtonian compounds that solidify including those that solidify against machining (eg cornstarch and water which stiffen in response to applied cutting forces — such examples may also benefit from applied sonic vibrations; cornstarch and oil as an electrorheological liquid that will stiffen on application of an electrical stimulus). Advantages being the control of airborne particulates and the apparent self-healing nature of some such materials which may flow into previously cut interstices (such as voids);

granules/powders/other solids (eg ferrous powders or granule (eg iron powder) which can flow into some materials having a plurality of interstices (such as a network of voids) then form a quasi-solid on application of a magnetic stimulus (being that the friction between granules and the foam will essentially lock it in place). Such powders/granules can be removed through gravity and/or sonic agitation, optionally in combination with magnetic forces and/or in a liquid to enhance this). In general, an advantage of powders or granules with the use of magnets is the ease at which the powders or granules can be separated from waste material;

granules/powders/other solids which can flow into some materials having a plurality of interstices (such as a network of voids) without any magnetic influence or other change in condition. For example a foam may be secured in a vessel having walls; an additive powder is agitated into the plurality of interstices (such as a network of voids) of the foam as well as any spaces between the foam and vessel walls; the foam with powder additive is thus placed in a packed and supported condition such that the foam and additive may be shaped; before the shaped foam is agitated (such as after removal from the vessel) to remove the powder additive. Nominal advantages of using granules/powders/other solids that can flow into some materials having a plurality of interstices (such as a network of voids) are: a possible reduction in energy requirements without the need for substantial heating as the powder can be vibrated in and vibrated out or melted out if required; faster processing time as the additive does not require cooling; and little to no change in the size of the filled foam and empty foam as there is no thermal expansion;

granules/powders/other solids that are capable of undergoing a change in condition such as being meltable. In such examples, the granules/powders/other solids can flow into some materials having a plurality of interstices (such as a network of voids). For example a foam may be secured in a vessel having walls; an additive powder is agitated into the plurality of interstices (such as a network of voids) of the foam as well as any spaces between the foam and vessel walls; the foam with powder additive is thus placed in a packed and supported condition such that the foam and additive may be shaped; before the shaped foam is agitated (such as after removal from the vessel) to remove the powder additive application of heat to the packed and supported foam will allow the granules/powders/other solids on the exterior surfaces of the composite to melt and create a partial or complete seal of the granules/powders/other solids and foam composite. Likewise the bottom surface could be melted to adhere to a work surface, for example. Nominal advantages of using granules/powders/other solids that can flow into some materials having a plurality of interstices (such as a network of voids) are: a possible reduction in energy requirements without the need for substantial heating as the powder can be vibrated in and vibrated out or melted out if required; faster processing time as the additive does not require cooling; and little to no change in the size of the filled foam and empty foam as there is no thermal expansion;

liquids that can be hardened or could be arranged and oriented to be stiffer by other means (eg ferrofluids; liquids that harden in response to a stimulus and will revert to liquid without; starch solutions left to dry or set using heat; proteins such as gelatine/collagen presented in solution form which then undergo intermolecular gellation).

Preferably the additive will be a wax or wax-like compound.

As used herein the expression “wax or wax-like compound” refers to a compound that is sufficiently solid, hard and/or stiff above the freezing point of water (0° C. at standard atmospheric pressure, 101.325 kPa) to facilitate the performance of the method of the present invention enabling the production of a desirable shaped material, but melts or softens without decomposing at temperatures above about 60° C. (such as above about 50° C., such as above about 40° C.). More typically “wax or wax-like compound” refers to a compound that is generally solid, hard and/or stiff above 15° C. (such as above 20° C.), but melts or softens without decomposing at temperatures above about 60° C. (or above about 50° C., or above about 40° C.). By way of example only, such a wax or wax-like compound is a greasy additive that flows at >25° C., becomes almost a gel at just below 25° C. and could be considered machinable (even if low quality) at any temperature below this but cooling below 0° C. would improve machining results. An example of such a greasy additive is a partially hydrogenated oil that is a paste or is gel-like at 25° C. but becomes flowable above this so that it could permeate a foam. Such an additive remains stable in the foam at 25° C. and could provide an increasingly machinable result with decreasing temperature. At below 0° C. it may be as stiff as paraffin wax at 25° C. To be contrasted with water, such a greasy additive will be sufficiently restrained in the voids of the foam above the freezing point of the additive, including at a machining temperature of 25° C.

Waxes are generally organic in nature (generally aliphatic hydrocarbons) and insoluble in water at room temperature. Waxes may be water wettable and may form creams, gels and/or pastes in some solvents, such as non-polar organic solvents. Waxes may dissolve in some non-polar organic solvents, typically with the addition of heat. Waxes may spontaneously emulsify in the presence of some liquids to form microemulsions, and/or may form emulsions with some liquids in the presence of surfactant(s).

Waxes may have melting points ranging from about 40° C. to about 150° C. In this sense, melting may also occur to a sufficient degree below 40° C. so as to facilitate incorporation within the plurality of interstices (such as a network of voids) of the material. It will be understood that incorporation may be achieved whilst only a portion of the wax is substantially liquid, the remaining portion being microcrystalline, for example.

Waxes can also be defined by viscosity. Viscosity measures a material's internal resistance to flow, wherein a material with a high viscosity is considered “thicker” and less fluid than a material with a low viscosity. The melt viscosity of waxes may range from low to high, and typically depends on the molecular weight of the wax, the crystallinity, and whether or not the wax is oxidized or copolymerized. Increasing molecular weight and density of the wax increases the melt viscosity of wax, and increasing the crystallinity of the wax decreases the melt viscosity. The friability of a wax, namely its affinity to be reduced in particle size by mechanical forces, increases with higher crystallinity and decreases with increasing density and molecular weight of a wax. The melt viscosity of waxes above their melting point is typically low.

Suitable waxes include both natural and synthetic waxes. Suitable waxes may include:

animal waxes (such as beeswax, Chinese wax, shellac wax, spermaceti and wool wax (lanolin));

vegetable waxes and hydrogenated vegetable oils (such as bayberry wax wax, carnauba wax, castor wax, esparto wax, Japan wax, Jojoba oil wax, ouricury wax, rice bran wax, soy wax, and hydrogenated oils from vegetable waxes—particularly those that are pastes/greases at room temperature);

mineral waxes (such as ceresin waxes, montan wax, ozocerite wax and peat waxes);

petroleum waxes (such as paraffin wax and microcrystalline waxes); and

synthetic waxes (such as polyolefin waxes, including polyethylene and polypropylene waxes, wax grade polytetrafluoroethylene waxes (PTFE wax-like grades), Fischer-Tropsch waxes, stearamide waxes (including ethylene bis-stearamide waxes), polymerized a-olefin waxes, substituted amide waxes (e.g. esterified or saponified substituted amide waxes), polyethers (such as polyethylene glycol, such as PEG2000) and other chemically modified waxes, such as PTFE-modified polyethylene wax)

as well as combinations of the above. Of these, the preferred waxes include hydrogenated vegetable waxes (such as palm waxes and soy waxes) and polyethers (such as polyethylene glycols). Hydrogenated vegetable oils and solid fractions of lanolin are especially preferred for the environmental and sustainable benefits that they provide to the methods and products of the present invention. Otherwise, paraffin, microcrystalline, and a variety of synthetic waxes are preferable.

It will also be appreciated that many other additives such as sugars, sugar alcohols, salts, iron powder are also preferred from an environmental/sustainable/resource recyclability perspective.

Other examples of additives include dry ferrous powder or a composition containing ferrous particles (such as a colloid) the properties of which could be modulated by magnetic stimulation to orient in such a way to stiffen the foam once incorporated. Further examples of additives include: non-Newtonian material that stiffens in response to a stimulus such as high frequency mechanical waves; or a liquid crystal that arranges upon electrical stimulation to a stiffened state. These examples could allow for the modulation of the additives properties and increase the ease of additive removal.

Specific examples of additives that have been tested in the processes described herein include the following, which are listed together with perceived advantages:

PEG1000-3000—hardness, machinability, reduction of airborne particles, melting point, water solubility

PEG3000-20000—hardness, machinability, reduction of airborne particles, melting point, water solubility

Paraffin wax—hardness, machinability, reduction of airborne particles, melting point

Additives possessing additional qualities pertaining to sustainability, renewability, environmental impact Include the following:
Xylitol, Erythritol, Sorbitol; eutectics of Erythritol/Xylitol, Erythritol/Sorbitol, Sorbitol/Xylitol—hardness, melting point, machinability, water solubility
Behentrimonium Methosulphate 25, Glyceryl mono stearate, Stearic Acid—hardness, melting point, machinability, reduction of airborne particles
Sodium acetate trihydrate—hardness, melting point, machinability, water solubility
Soy, palm, castor waxes and mixtures—hardness, melting point, machinability, reduction of airborne particles
Isosorbide and 1,6-Hexanediol—hardness, melting point, machinability, reduction of airborne particles
Starch/water mixtures—water solubility, machinability, reduction of airborne particles
Iron powder—hardness, machinability

If the intention is to swell the material having the plurality of interstices (such as a network of voids), such as foam (such as polyurethane), for machining then the following non exhaustive list of additives is preferred:
Trimethyl citrate, Pantolactone (racemic), Diacetone Acrylamide, Methyl Nicotinate—hardness, melting point, machinability, water solubility
Crotonic Acid - hardness, melting point, machinability, water solubility and precipitates from a cold solution

As used herein the term “contacting” in the expression “contacting the material with an additive so that at least a portion of the additive is incorporated within at least a portion of the” plurality of interstices (such as a network of voids) of the material refers to any process by which the material and the additive are brought into intimate contact so that at least a portion of the additive is incorporated in such a manner. In this context, the term “portion” may refer to at least 5%, such as at least 10%, such as at least 15%, such as at least 20%, such as at least 25%, such as at least 30%, such as at least 35%, such as at least 40%, such as at least 45%, such as at least 50%, such as at least 55%, such as at least 60%, such as at least 65%, such as at least 70%, such as at least 75%, such as at least 80%, such as at least 85%, such as at least 90%, such as at least 95%. The material may or may not be completely saturated (100% incorporation of additive in the interstices) with the additive. This process may involve the use of any one or more of the following: pouring; soaking; agitation; vibration; use of reduced pressure (such as by application of vacuum); use of increased pressure. Such methods may make use of a combination of such techniques.

The use of reduced pressure may involve placing the material and the additive in a vacuum chamber of fixed volume or a vacuum chamber of variable volume (such as a bag), after which stage the pressure of the chamber is reduced, thereby causing gas incorporated in the material to expand and escape from the material to be replaced by the additive. In one embodiment, a foam material is placed in a bag and the gaseous contents of the bag removed by vacuum and the foam compresses, before an additive is allowed to be introduced into the vacuum chamber as the foam expands and/or causing the foam to expand so as to incorporate the additive. The additive can be introduced into the vacuum chamber through the same or a separate port, in such a manner that the vacuum in the chamber is reduced and the material expands (such as by using a peristaltic pump). This vacuum method can be particularly useful when incorporating molten wax within a foam, although typically it is desirable to ensure incomplete saturation in such an embodiment. In some embodiments, the material having the plurality of interstices (such as a network of voids), eg foam, and the solid additive are placed within a vacuum bag; a vacuum is applied to the bag via an opening which compresses the material and extracts all or some of the air; the outlet is subsequently sealed and the vacuum bag is heated (such as being placed into a heated liquid) to melt the additive thereby causing the melted additive to be drawn into the material as it melts resulting in a fully expanded material with additive throughout when the bag contents are returned to atmospheric pressure. Some nominal advantages of this method include: a simple equipment setup requiring less space and reduced spillage and hazard exposure; improved repeatability and consistency by measuring the weight of additive required; and improved reliability with fewer pipes requiring heating to prevent premature hardening and blockages.

In some embodiments a shaped vacuum bag may be used to act as a mould so that the material having interstices (eg voids, eg foam) can cool and harden without being removed from the bag. The vacuum bag itself can be shaped or consist of one or more solid members having a shape (such as: two solid plates with a silicone gusset or skirting joining the two; or one plate with a vacuum sheet sealed around the perimeter). When vacuum is applied it provides a flat pressure across the material and when vacuum is released it provides a flat surface for the material to cool on. In some cases a bottom plate could be present as the intended work surface and placed onto the machine bed for shaping. Alternatively one or more of the plates could be shaped (such as a mould). Nominal advantages being: simple equipment set up requiring less space and reduced spillage and hazard exposure; consistently flat and square material (eg foam) as it hardens; reduced warp if using two plate setup on thinner sheets as it can be gently sandwiched/restricted from distortion; and/or a possible reduction in process time and energy requirements for particular requirements (if only smaller pieces are required or if preparing large slab stock is not possible).

In some embodiments, the additive may be used to expand the material having the plurality of interstices (such as a network of voids). For example: the material (eg foam) may be contacted by an additive which swells the material; the additive hardens so the material is now in a swelled state; the material is shaped; and the additive is removed and the material returns to its original size. The method provides the nominal advantage that it can improve the infiltration of very fine foams by increasing the overall size of the material and therefore the flow of additive into the material; and improve machining resolution by shaping at an enlarged size.

Another variation on the use of reduced pressure is the application of force to an elastic or a viscoelastic material having a plurality of interstices (such as a network of voids) so that the material compresses and expels at least a portion of the contents of the voids from the material. Upon relaxation of that force, and in the presence of an additive, the material expands thereby incorporating at least a portion of the additive in the material. For example, a foam could be submerged in a bath or bag of liquid wax, the foam could be compressed so as to expel any incorporated gas, and then allowed to expand to incorporate some of the liquid wax from the bath. In some embodiments it is desirable to saturate the material with additive, whereas in other embodiments it is desirable to only partially saturate the material with additive. In this example, the amount of gas that is expelled could be varied depending on the degree of compression of the material. The amount of gas that is present in the material could also be modulated by a number of techniques including withdrawing the partially compressed material from the bath prior to the material being allowed to fully expand. Another technique involves only partially compressing the material so that the product material incorporates a portion of additive and a portion of gas. In a further technique, a material is allowed to soak preferentially and unevenly from, for example, one aspect of the material so that for example the material incorporates additive on one face to a greater degree than other parts of the material. It has been found that such methods allow the user to produce a material incorporating a desired ratio of gas to wax. Similar method(s) could be applied to other materials and/or additives. It will be understood that the ability to compress the elastic or a viscoelastic material having a plurality of interstices (such as a network of voids) represents a significant departure from prior methods that are used on non-elastic or non-viscoelastic materials.

Advantageously the method of the present invention allows for modulation of the amount of additive to be incorporated and also modulation of where the additive is incorporated within the material. For instance the additive can be focused in specific areas to enhance the method and/or product. For example an amount of wax may be incorporated within a foam to a degree sufficient to merely coat the surfaces of the voids and immobilise a majority of the foam. As another example, an amount of wax may be incorporated only in the top machining layer of the foam thereby substantially rigidifying the material and providing the higher quality surface finish. Modulating the amount of additive that is incorporated in the material allows for a decrease in the amount of additive required, thereby potentially facilitating easier removal of the additive.

Whilst the process of contacting the material with the additive has been described largely for a foam and a wax, the use of non-liquid additives is also contemplated. For instance, additives that are granular, powder or mixtures thereof, particularly those that could flow may be incorporated in the material by being poured, or even the use of reduced pressure, particularly where the additive may be air-borne.

As used herein the expression “subjecting the material to conditions so that at least a portion of the incorporated additive solidifies, hardens, and/or stiffens” refers to providing one or more external stimuli to modify the conditions experienced by the material and additive. Examples of such stimuli include magnetic, electric, thermal, chemical, mechanical and electromagnetic.

Typically the stimulus will be a thermal stimulus, for example a stimulus leading to a reduction in temperature of the additive. For example, the stimulus may simply be a reduction in temperature of the environment in which the additive (and material incorporating the additive) is, such that the temperature of the additive reduces so that the additive solidifies, hardens, and/or stiffens, as would be expected when a wax changes from a liquid state to a substantially solid state.

As indicated above, examples of other stimuli include: magnetic stimulation; the application of force (including shear) such as by the application of high frequency mechanical waves; or the application of electrical stimulation.

In some embodiments it may be desirable to further manipulate the material before shaping. Examples of manipulation may include; pressing, embossing, moulding, folding, joining, splicing and/or inserting pieces of material before the additive is hardened or introduced. The purposes of which may include the pre-forming of shapes (such as a mould), smooth machining of multiple joined/spliced pieces of material or pressing/compressing the material to reduce the amount of additive required. For example pre-forming or compressing the material with an additive can be used to simplify and speed up some operations. In such embodiments, for example compression may typically occur with a positive mould (and mirror image) if replicating a shape—for example, to produce a foam hemisphere the mould would be a positive hemisphere and the highest point of the hemisphere when pressed into the foam would be the lowest/most compressed part of the foam and would emboss a negative impression into the foam. Hence, the process would include the steps of: contacting a foam with an additive then placing it in a mould that compresses and embosses a hemisphere in the center; the foam and additive harden in the mould; the hemisphere embossing is substantially lower than the rest of the foam and therefore excludes it from the cutting operation; if the foam in this case is only face milled or planed to the depth of the embossing the resulting foam when the additive is removed will have a positive hemisphere shape protruding higher than the rest of the foam. In another embodiment, the process includes the steps of: stamping a sheet of foam with liquid additive with a positive mould; hardening the additive and holding the compressed state or embossment; cutting the material to remove the uncompressed portion; heating the additive and removing the additive to reveal a positive replication of the mould. Such processes could be advantageous to quickly create standard shapes or the general shape of the article before progressing to further shaping or for easily creating textures which otherwise may be time consuming to form. This may be used as an alternative to foam convoluting machines but with the additive able to hold the shape until removed. It is believed that the additional benefits are: more complex shapes can be formed; further machining can be done to the compressed foam; it is not restricted to compression by rollers; foam slab stock can be kept at room temp with a compressed shape or texture ready for further shaping; it allows for mass production of items using the original method. Possible further advantages of this are that pre-compressed foam blanks could contain an impression of, for example, a standard wheelchair seat. Hence, one cutting pass can provide the basic shape followed by a calculated pass to customise the shape to a particular customer. This would effectively reduce the depth of cuts required, increase speed, and reduce additive volume. Furthermore the compressed foam is not permanently formed until the foam material is removed by machining. For example, a foam sheet with a convoluted embossing can be heated and the foam returned to a normal square foam sheet. If it is cut flat across it would produce a convoluted sheet. Knowing the compressed shape and dimensions it is possible to still shape the foam beyond the impressed shape by compensation such that selected peaks of the convolution could be removed by machining the compressed portions; or convolution troughs could be removed by not machining the uncompressed portions. Overall these processes allow the core methods of the present invention to be extended from custom manufacture to higher volume mass production with the addition of flexibility and customisation. In such embodiments, the process of compressing can be by way of, for example: compressing before cooling; partially saturating and cooling the foam then pressing and bonding the compressed cells; using a cold press to harden portions of the foam rapidly. Alternatively this can be done using variations of the additive described above with their respective advantages (powders, waxes, dry powdered additives etc). As can be seen, these processes can be paired with the core methods of the invention by using compression/embossing one side and performing more complex machining on the opposing side.

Prior to and/or during the process of shaping the material, the material will typically be held securely in place so that the shaping device, for example, is mobile and moves around the immobilized material. Advantageously certain embodiments of the present invention allow the material to be held securely to a surface in such a manner that the material can also be removed from the surface with relative ease at the completion of the shaping process. In particular, a heated/cooled work surface can be used such as provided by hydronic heat transfer. Where the additive solidifies, hardens, and/or stiffens as a result of being subject to a reduction in its temperature, such as a wax, a foam incorporating that additive can be positioned on the surface at a given elevated temperature (typically exceeding the melting temperature of the wax) and secured to the surface by reducing the temperature of the surface to, for example, below the melting temperature of the wax. It has been found that a material subject to these conditions remains sufficiently secured to the surface to allow the shaping process to take place. At the completion of the shaping process, the temperature of the surface can be increased and the material will loosen and be able to be removed and/or repositioned. Such techniques provide a significant advantage over prior published processes that require the use of clamps, strong adhesives (such as superglue), which are understood to damage the material and are limited in the possible machining geometry.

As used herein the expression “shaping the material” refers to any process by which the material is modified from one shape into a different shape. Generally the present invention is best suited to subtractive shaping processes including hand-shaping and machining. Examples of machining processes include computer numerical control (CNC) machining, such as contour-machining. Such machining includes the use of lathe, mill, turn-mill, multi-axis mechanical arm, multi axis water jet, laser, hot wire, sonic-knife, reciprocating blades/saws, knives, ablation tooling.

Preferably the machining process will use CNC machining, an example of subtractive machining, with a definable tool depth or end. Such processes having a definable tool depth or end typically include spindle (Mill and turn-mill) or a combination of spindle and feeding non-rotating tool (lathe and turn-mill), ultrasonic tool(cutter non-rotary), reciprocating tool (reciprocating and concentric cutters), concentric rotary tool, grinding/sanding/rasping/burr tool.

Such processes having a definable tool depth or end typically exclude processes such as lasers, water jets, plasma cutter and air jets and band saws, chainsaws and wire cutters that do not cut at a point or on the radii of a guide.

As used herein the expression “removing at least a portion” of the incorporated additive refers to such processes as the following:

agitating (eg shaking, vibrating, compressing (which may be slow or fast; and may be repeated any number of times in a compression/expansion cycle), or the use of centrifugal forces) the material incorporating the additive so that at least a portion of the additive is fragmented and becomes unincorporated, at which stage the unincorporated additive can be isolated;

placing the material incorporating the additive in a bath of liquid, followed by optional agitation (eg shaking, vibrating, compressing, or the use of centrifugal forces). The bath of liquid may be at a different temperature (eg warmer) than the material before it is placed in the bath. The liquid may be a liquid that is immiscible with the additive. In one embodiment the additive (eg wax) melts and becomes unincorporated and separates from the material. For example:
the material incorporating wax can be placed in a bath of warm water and agitated so that the wax melts, separates from the material and partitions from the warm water, accumulating on the surface of the warm water;
the material incorporating wax may also incorporate a surfactant optionally in admixture with the wax. Once placed in a bath of (optionally warm) water and agitated, the wax melts and the surfactant solvates, allowing formation of an emulsion of the wax and surfactant;
the material incorporating wax can be placed in a bath of (optionally warm) water incorporating a surfactant and the material can be agitated so that the wax (optionally melts), separates from the material and emulsifies in the water;
the material incorporating wax can be placed in a bath of (optionally warm) solvent (that is capable of solvating the wax) and the material can be agitated so that the wax (optionally melts), separates from the material and dissolves in the solvent.

agitating (eg shaking, vibrating, compressing (which may be slow or fast; and may be repeated any number of times in a compression/expansion cycle), or the use of centrifugal forces) the material while the material is exposed to heat so that the at least a portion of the incorporated additive melts and drains from the material. For example:
In one such embodiment this process could be performed by applying heat to the material incorporating the additive so that at least a portion of the additive melts, before compressing the material to expel a majority of the additive from the material;
In another such embodiment, both heat and compression could be continuously applied until the desired level of additive is removed;
In another such embodiment, the material may be placed in a bag, the contents of which is subject to reduced pressure through vacuum, before the bag is subject to heat so as to melt the additive which can then be removed from the bag under vacuum.

It will be understood that any of the foregoing methods can be used to effect a partial or complete removal of the additive from the material. Typically such methods will effect a partial removal of the additive from the material. In such embodiments it may be desirable to remove residual additive using a secondary removal process. Such secondary processes include any one or more of the above removal techniques. For example:

The application of solvent to the material incorporating residual additive, optionally combined with agitation (eg shaking, vibrating, compressing, or the use of centrifugal forces).

The step of removing at least a portion of the incorporated additive may precede a further step of recovering the surfactant, wax and water for reuse.

In the twelfth and thirteenth aspects, the invention provides a method of forming a shaped elastic or viscoelastic material having a plurality of interstices (such as a network of voids), the method including the steps of:

i. in a vessel contacting an additive with a resin capable of being cured to form an elastic or viscoelastic material to form a mixture;

ii. degassing the mixture, such as by vacuum, and/or mixing the mixture to form a homogeneous blend;

iii. curing the resin so as to form an elastic or viscoelastic material incorporating at least some of the additive;

iv. shaping the material incorporating the additive so as to form a shaped material incorporating the additive; and

v. optionally removing at least a portion of the incorporated additive from the shaped material incorporating the additive,

wherein the additive is not water and the additive solidifies, hardens, and/or stiffens when subject to changes in conditions selected from: thermal, magnetic, electrical, chemical, and/or electromagnetic.

This aspect differs in some ways to the other aspects in that the elastic or viscoelastic material is formed from a resin which is already in contact with the additive. However it shares several similarities. In particular the shaped elastic or viscoelastic material the method forms is potentially indistinguishable from a shaped elastic or viscoelastic material formed by the other methods disclosed herein. The resin method may offer certain advantages/disadvantages over the methods that contact the additive with the elastic or viscoelastic material.

The resin may be shrinkable (by heat, electromagnetic radiation, electro etc) so the foam is shaped at a larger size and shrunk down. Nominal advantages of this method include allowing the shaping of micro structures which may otherwise be too small too machine; and/or improving the accuracy of machine equipment—for example shaping at twice the size would effectively double the machining tolerance when the material is finally shrunk down. This resin technique could be applied to: developing implantables; soft robotics; reproduction of very small biological structures. In the case of soft robotics the resin may be reversibly controllable providing novel types of multicellular pumps or muscle analogs. This technique could also be paired with 3D printing whereby: the additive is 3D printed to form desired interstices (such as networks of voids) and coated in resin; and the additive and the resin are 3D printed. As can be seen, this tenth aspect is fundamentally different from the 3D printing of shrinkable resin per se, since that method does not involve the use of an additive defined herein and a subsequent machining step.

In some embodiments the additive could be aerated before bead forming, have a sufficiently low vapor pressure, or contain a mixture which could off-gas. In such cases, the process may include the steps of: combining additive (such as beads) with a resin; curing the resin; placing the cured resin containing additive having a sealed skin around its exterior in a vacuum chamber so as to produce a cured resin with additive in the form of a foam incorporating additive as space holders; raising the temperature of the vacuum chamber so that the additive is melted and the pressure is lowered (in this event, in the case of aerated additive the trapped air expands and therefore expands cells in the foam); cooling and hardening the additive to retain the expanded state of the foam at normal atmospheric pressure; shaping the expanded foam so as to break the sealed exterior skin; heating the material so that the additive can be removed and the foam returned to its original size.

Many of the aforementioned processes for removal of additive advantageously avoid the use of harmful solvents (compared with prior published methods) thereby reducing hazards, storage and costs associated with solvents in prior published methods.

Where solvent can be avoided, the present invention increases the variety of materials suitable for the method as the additive and removal method does not damage the material whereas solvent compatibility is not consistent across all material (especially foams).

A further advantage is the ease of emulsification particularly when the additive is incorporated in admixture with a surfactant, whereby the use of agitation combined with the close proximity of the surfactant to the additive removes the problems of solvent penetration if removing deeply embedded additive as may be found in much larger articles.

The present invention provides numerous advantages over prior published methods. The prior published methods do not address the environmental impact of their method or disclose any progressive solutions. In contrast, the present invention allows for the recovery of additive thereby providing a progressive environmental and sustainable method. For example, the ease of extraction and recovery of the additive allows for the reuse of additive, material, and solvent (including water) in a closed loop system. It has been found that the use of additives derived from sustainable renewable resources can provide improvements in environmental and sustainable impacts. A further advantage is that the invention could be adapted in such ways to enhance the adoptability, quality, time and cost associated with storage and equipment by contracting one or more of the process steps to third parties. One such way could be the licensing of a third party to perform the step of incorporating the additive in the material so as to reduce costs, increase quality and improve consistency. The prepared material could be delivered as needed to parties that intend to perform the shaping of the material and removal of the additive. The third party could then collect the additive and prepare new material and efficiently recycle foam waste material. If necessary the third party could perform further processing of the additive or reformulating if it is required. This would allow smaller entities to adopt the method and allow the handling of additive to be dedicated to larger entities or emerging parties specialising in the handling and formulation of the additive and handling of any waste materials.

Another adaptation to reduce material waste facilitated by the present invention could be the preparation of shaped foam blanks for machining, such as foam seating orthoses blanks that could be machined to a specific need instead of machining large quantities from a square foam block to reach the same shape as the orthosis blank.

A further advantage of the invention is the control of particulate material (such as dust) during machining which removes the need for extraction equipment as the additive binds to the waste material during machining thereby effectively encapsulates the particulate materials therefore largely eliminating airborne particles.

An advantage over other methods of producing shaped materials (such as foam articles) is the reduction of storage needed for storing moulds which require either large storage areas or the re-making of moulds from CAD files.

A further advantage is the ability to prepare the material with incorporated additive and store the prepared material for extended periods of time without the need for particular storage conditions (such as cold storage needed for some prior published methods). In this way, stockpiling of prepared material (eg foam) could be done in large slabs or predetermined sizes and shapes. Pieces could be taken from slabs only as needed which increases the cutting economy to reduce waste. Additionally the cost of equipment and space required could be further reduced by enabling third parties to prepare the material and supply to the entity intending to shape the prepared material.

The present invention may also make use of 3D modelling. In methods departing from the traditional methods of mould making, the use of minimal or non-contact 3D measurement, mapping and/or tracking could be utilised to produce data that could be manipulated using CAD/CAM methods and subsequently output in a form for machining. 3D Measurement, mapping and tracking could comprise of typical medical imaging; MRI, CT, X-ray or Ultrasound or, 3D scanning, motion tracking and mapping techniques or, pressure mapping and impression mapping.

### EXAMPLES

The following examples of the invention are not exhaustive and are provided for illustrative purposes only.

An open cell flexible foam block (2) (which is an example of an elastic or viscoelastic material having a network of voids) is provided to be shaped by machining. In one embodiment, the block (2) can be saturated in a mould (4) for full incorporation of the additive. The mould can have an open bottom (10) to allow the block to be secured to a machine bed, or the mould can have a closed bottom (12) to allow the block to be moved around after the additive has been incorporated, separate from the machine bed. In either case, the block may optionally undergo partial addition/removal of any additive through the use of a plunger (16). The mould may then be removed from the moulded product, either secured to the machining bed (20), or separate from the machining bed (22). Where the material incorporating the additive (22) is separate from the machining bed, it may be subsequently secured to the machining bed through a separate heating step to remelt some of the wax (26) and secure it to the machining bed. In another embodiment, the block (2) can be contacted with hot melted wax in a bath (6) at, for example, 50-80° C., and be optionally subject to agitation by compression (14) using a plunger. The foam material may then be removed from the bath and allowed to drain excess additive (18) where desired to allow partial saturation. An optional secondary saturation step of one aspect (a face) of the foam material (24) may be provided. In either case the foam material may be secured to the machining surface through a separate heating step to remelt some of the wax (26) and secure it to the machining bed. In another embodiment the block (2) can be placed in a bag (8) to which is applied a vacuum to reduce the air in the foam before hot wax is pumped in to fill the air space and evenly saturate the foam. Upon removal of the foam material from the bag the foam material may be secured to the machining surface through a separate heating step to remelt some of the wax (26) and secure it to the machining bed.

The secured material (28) may then be machined using a range of processes. In one embodiment the material can be machined by single sided machining (30), the product of which can be removed from the machining bed through the application of heat (34). In another embodiment the material can be machined by two sided machining (32) achieved by leaving a border to create a trough. The trough (36) can be filled with wax or even a wax/waste (44) slurry before the upper surface is machined level. The piece (38) can then be subject to heat to remove the piece from the bed (40) before being turned and reannealed (42) to the machining surface. The turned piece can then be machined (46) to a two sided machined product (48) and removed from the machining bed (50).

In any embodiment, the material can be placed in a hot bath of wax (52) so as to remelt the additive. Removal and the application of agitation (compression) (54) can be performed to remove the majority of wax. Alternatively the material may be placed in a bag to which vacuum and heat is applied so as to remove melted wax from the foam material. The finished piece (58) may be washed or wax residue could be left in to impart some water repellency, conditioning, and/or antibacterial properties. Washing may be performed using: warm detergent (surfactant) solution in a bath; ultrasonic bath using detergent and heat; continuous warm water flow or with detergent; warm detergent bath with agitator or compression. Alternatively solvent could be used to reclaim residual wax through any of the relevant aforementioned methods.

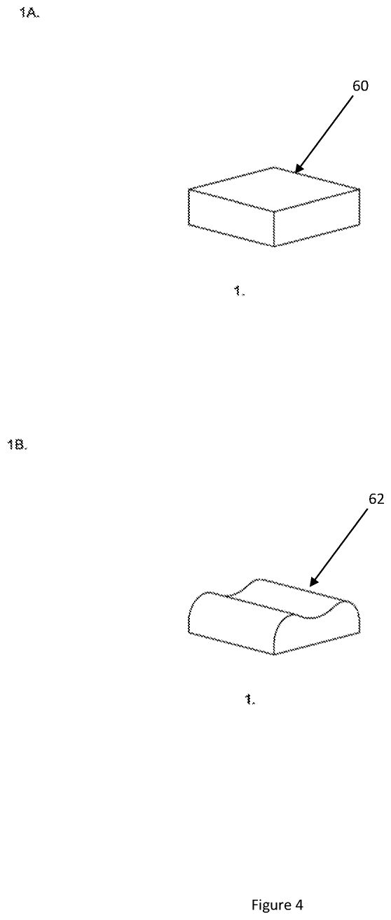

FIG. 4 shows that the methods of the invention may be applied to a multitude of shaped stock (60) as seen in Step 1A. Or to a shaped blank (62) to customise or machine to tolerance; or for reworking a previously shaped material as seen in Step 1B.

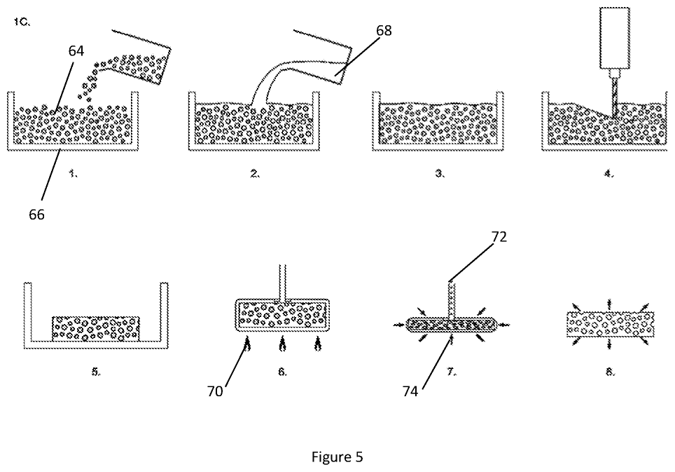

FIG. 5 shows an example of a method of the invention. In particular, step 1C illustrates an alternative process where the solid additive (64) is used to form the voids of the resulting material when the additive is removed. Step 1 involves placing the solid additive (64) in a receptacle (66). Step 2 involves adding the bulk elastic/visco-elastic material (68). Step 3 involves degassing or mixing of additive and aforementioned bulk material if desired and retaining in the original receptacle or transferring to another receptacle/s followed by curing, hardening, setting of bulk material. Step 4 involves shaping of cured bulk material/additive mix. Step 5 involves completion of shaping or further shaping operations to achieve desired shape. Step 6 involves heating (70) of the additive, which can be performed in a multitude of ways with or without a vacuum bag. Step 7 involves removal of additive by vacuum (72) and/or by compression (74) means. Step 8 provides the finished article. Further cleaning or treating may be undertaken if desired.

As a particular example of the method, molten paraffin wax is dripped at a constant rate into a bath of cold water to quickly cool and form roughly spherical shaped beads. The paraffin is dripped from a height sufficient to form individual droplets but not so high as to produce irregular shaped pieces (e.g. flat splatter shapes). The bath having a constant circular flow transports the paraffin beads away from the point of release to minimise fusing and aggregation of the beads. The paraffin beads are removed from the bath and dried. The beads are placed into a rectangular vessel and a two component addition-cure silicone is prepared and added to the vessel. The vessel with the uncured silicone and beads is placed in a vacuum chamber and subjected to reduced pressure to remove undesirable pockets of trapped air. The vessel is removed from the vacuum chamber and the silicone is left to cure. Once cured the silicone with paraffin beads can be removed from the vessel resulting in a rectangular silicone block with incorporated paraffin beads. The rectangular block is affixed to the workbed of a CNC router and is machined to a desired shape. The machining process breaks the outer skin of the silicone which allows for removal of the paraffin additive. The shaped piece is heated to melt and remove the paraffin with the addition of compression. A detergent wash may be used to remove undesirable residue. The final product is a shaped open-cell elastic silicone foam.

In some embodiments, the additive beads can be selected from a range of appropriate materials including: waxes, wax-like polymers, salts, sugars, sugar alcohols etc. The silicone ‘resin’ as described can be substituted from a range of polymers characterised by such properties as: elastic/viscoelastic, resilient, soft, flexible etc. The ‘curing’ in a descriptive sense could describe a range of known methods depending on the base material, for example: drying, crosslinking by electromagnetic radiation, heat or synthesis.

Additionally the additive may have secondary properties or be manipulated in such a way to alter the final product. For example, an additive may be whipped to incorporate air into the mixture before producing the shaped beads, such that the solid shaped beads will contain a portion of air throughout. The process of curing the silicone around the beads is then performed followed by melting the paraffin bead(s) by heating the cured silicone. The heated silicone is then placed in a vacuum chamber. A vacuum is applied and the air bubbles dispersed throughout the additive expand. The skin formed around the exterior of the silicone prevents air from escaping the block of silicone material therefore causing it to expand in size. The silicone piece is then cooled in an expanded state to hold its shape. The piece is then machined and the additive is once again heated and removed allowing the silicone piece to return to its original size. This process preferably involves the following events:
The additive being formulated or melted in such a way that the air bubbles do not aggregate and prevent the holding of the expanded state;
The silicone expanding uniformly or predictably and without breaching the outer skin;
The strength of the additive when expanded is sufficient to hold the expanded state of the silicone for machining.

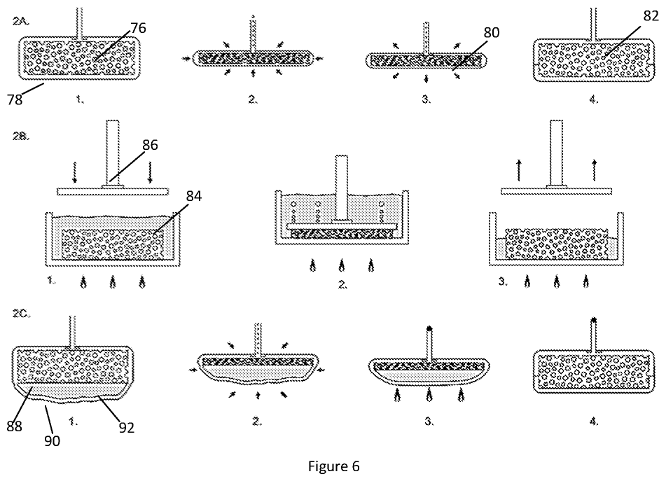

FIG. 6 shows various embodiments of the method of the invention including the step of contacting a foam with an additive:

Step 2A includes a number of substeps:
Substep 1 involves placing foam (76) from FIG. 4 (Step 1A or 1B) into a vacuum bag (78);
Substep 2 involves removing air in part or entirety to compress the foam;
Substep 3 involves introducing the additive (80) to contact the foam. This could be by the negative pressure of the foam expanding or injection by other means such as pump, syringe or other suitable means;
Substep 4 provides the resulting foam with the additive.

Step 2B includes a number of substeps:
Substep 1 involves a foam (82) situated in a vessel containing the additive (84; by way of example the additive is heated to liquid state) and a suitable press (86);
Substep 2 involves compressing the foam to expel all or part of air within;
Substep 3 involves the release of the press to allow additive to be drawn into cells.

Step 2C includes a number of substeps:
Substep 1 involves placing foam (88) in a suitable vacuum bag (90) or like vessel with the additive (92) in a solid state;
Substep 2 involves applying a vacuum to remove air and compress the foam resulting in a solid additive and compressed foam;
Substep 3 involves heating the additive and foam by a suitable means while still void of air or partly void of air;
Substep 4 involves drawing the additive (as it becomes liquid) into the compressed foam resulting in an uncompressed foam with incorporated additive.

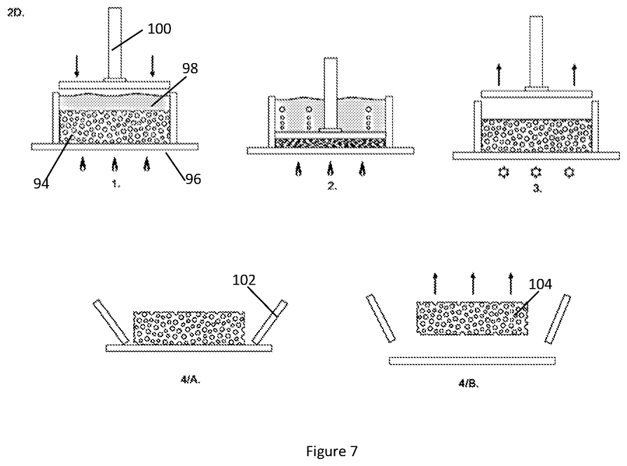

FIG. 7 shows a similar process to that shown in Step 2B wherein the vessel acts as a mould:

Step 2D includes a number of substeps:
Substep 1 involves situating a foam (94) in a vessel (96) containing the additive (98; by way of example the additive is heated to liquid state) and a suitable press (100);
Substep 2 involves compressing the foam to expel all or part of air within;
Substep 3 involves releasing the press to allow additive to be drawn into cells followed by the cooling of the foam/additive within the vessel;
Substep 4A shows the vessel or the base of the vessel is the intended workbed or a bed to be attached to a machine bed. The side (102) of said vessel can optionally be removed.
Substep 4B involves removing the hardened foam (104) from the vessel.

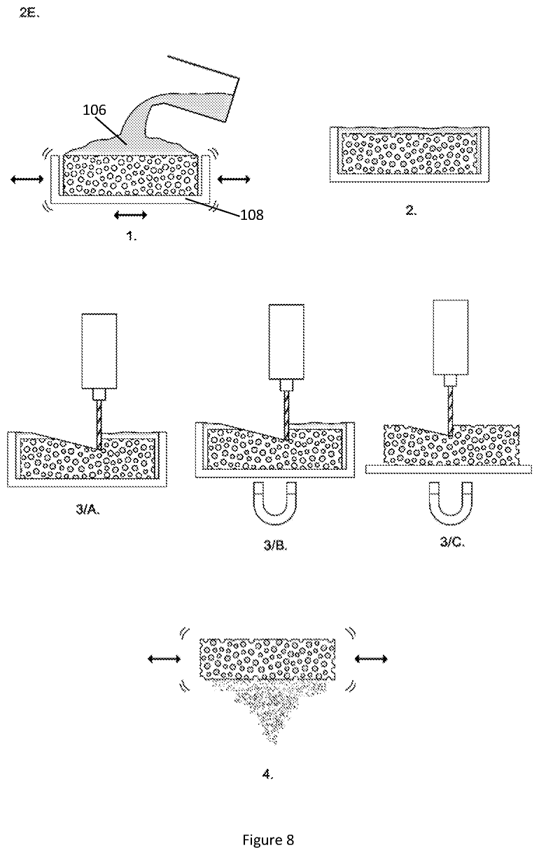

FIG. 8 shows a process wherein solid granules, powders etc are the additive and optional or if required can be manipulated by external stimuli—being solid or otherwise.

Step 2E includes a number of substeps:
Substep 1 involves applying an additive (106) as a solid granule to the foam (108) situated in a vessel which is agitated to facilitate the movement of the additive into the foam.
Substep 2 shows the additive within the foam
Substep 3A involves shaping the foam and additive within the vessel as a substantially more solid composite.
Substep 3B shows the additive undergoing magnetorheological change, so that the individual granules are held substantially firmer or restricted from movement by way of a magnetic field being applied in the vicinity of the vessel.
Substep 3C shows the additive undergoing magnetorheological change so that the individual granules are held substantially firmer or restricted from movement on a workbed or machine bed by way of a magnetic field.
Substep 4 shows shaped foam being agitated to remove the additive, which can be further enhanced by application of a magnetic field to help draw and collect the additive while additionally separating waste material from additive. This could be performed in a bath or dry elsewhere.

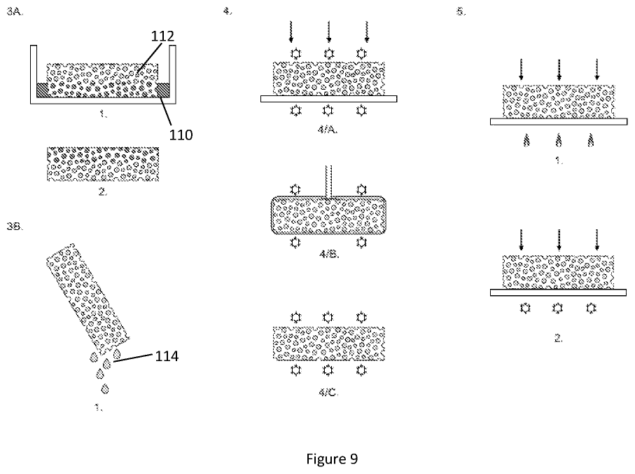

FIG. 9 shows how the addition or removal of heat can be used to modify the properties of the additive.

Step 3A includes a number of substeps:
Substep 1 involves concentrating the additive (110) in the desired region of foam by: cooling the additive and foam (112) by orientation; cooling with substantially more additive in the region of interest; or by reapplying to the desired region of already hardened foam
Substep 2 (in the case of a reduced additive requirement) the additive can be concentrated in the area to be machined to improve shaping

In Step 3B excess additive (114) can flow out or be compressed to the desired amount

In Step 4A foam can be left to harden and affix to the work surface.

In Step 4B foam can be hardened in a vacuum bag or other suitable vessel (including those of step 3A) which may be shaped such that it is a mould.

In Step 4C foam can be hardened by other means before affixing to a work surface

Step 5 includes the following substeps:
Substep 1 involves affixing the hardened foam to the work surface by heating the work surface or applying melted additive to the work surface with or without heated surface to adhere foam.
Substep 2 involves cooling the work surface to affix the foam or left to cool without additional cooling. Alternatively the foam can be affixed by any other means for example standard work holdings such as chucks, vices, clamps, vacuum holding.

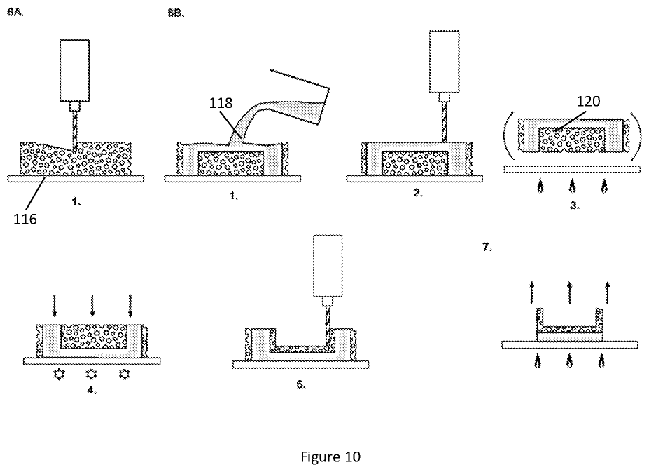

FIG. 10 shows, by way of example, how the process of FIG. 9 may be continued.

Step 6A(1) involves shaping the foam (116).

Step 6B illustrates a method for machining multiple sides including the following substeps:
Substep 1 involves applying additive (118) to surfaces or shaped troughs created prior followed by hardening.
Substep 2 involves facing the top so it is flat or shaped (such as for other mounting methods such as pegs, vices or interlocking members).
Substep 3 (in the case of foam affixed by an additive) the bed is heated and the workpiece (120) is repositioned.
Substep 4 (in the case of affixing by additive) the workpiece is positioned and the workbed cooled.
Substep 5 involves shaping the repositioned workpiece
Substep 7 involves removing the shaped foam from the work surface by application of heat.

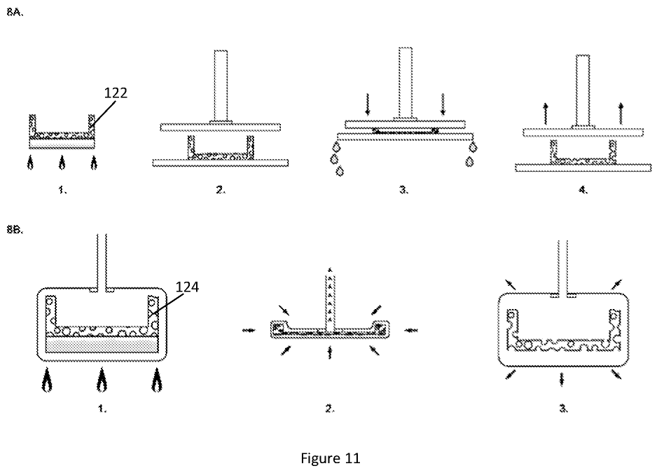

FIG. 11 illustrates the removal of the additive.

Step 8A includes the following substeps:
Substep 1 involves heating the shaped foam (122) by any appropriate means for example by conduction in a vessel of water or liquid additive or by radiant heat
Substeps 2,3,4 show the heated, shaped foam is pressed by a suitable means.

Step 8B includes the following substeps:
Substep 1 shows the shaped foam (124) being situated in a suitable vacuum bag or arrangement as described in the preface of the description. The shaped foam is heated by a suitable means as described in Step 8A. Vacuum may be applied before and during heating to improve this step.
Substeps 2,3 show vacuum being applied to remove the additive and then vacuum being released allowing the foam to expand. Optionally the bag can be compressed by some other means.

A further step of washing or removal of residue may be desired.

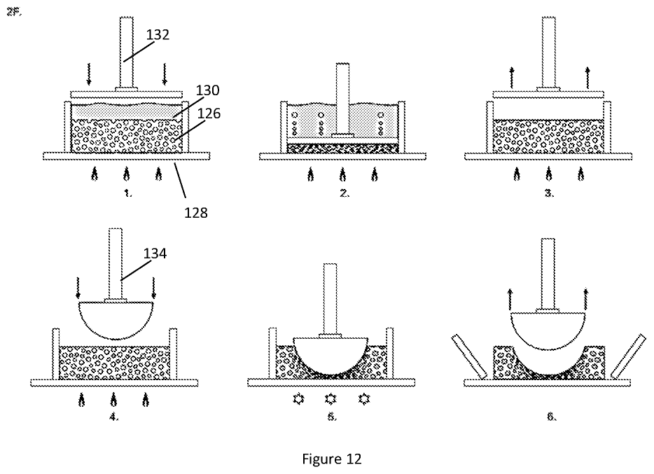

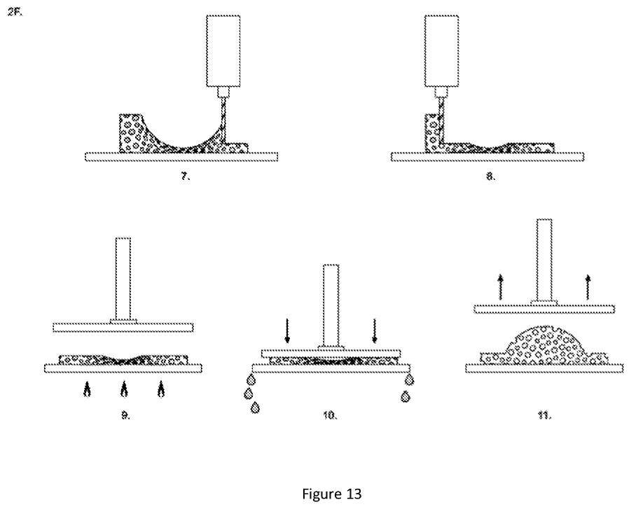

FIGS. 12 and 13 show how the addition or removal of heat can be used to modify the properties of the additive.

Step 2F includes a number of substeps:
Substep 1 involves situating a foam (126) in a vessel (128) containing the additive (130; by way of example the additive is heated to liquid state) and a suitable press (132);
Substep 2 involves compressing the foam to expel all or part of air within;
Substep 3 involves releasing the press to allow additive to be drawn into cells;
Substep 4 involves compressing the foam with a mould (134);
Substep 5 involves cooling of the foam/additive while compressed by the mould within the vessel;
Substep 6 shows the hardened foam with the impression of the mould;
Substep 7,8 involves the removal of foam material using a face machining operation (shaping);
Substep 9 involves heating the shaped foam by any appropriate means for example by conduction in a vessel of water or liquid additive or by radiant heat;
Substep 10 involves compressing the heated foam/additive;
Substep 11 shows the resulting foam displaying the shape of the mould.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A method of shaping an elastic or viscoelastic material having a plurality of interstices, the method including the steps of:
i. providing an elastic or viscoelastic material having a plurality of interstices;
ii. contacting the material with an additive so that at least a portion of the additive is incorporated within at least a portion of the plurality of interstices of the material;
iii. subjecting the material to conditions so that at least a portion of the incorporated additive solidifies, hardens, and/or stiffens;
iv. shaping the material incorporating the solid, hard, and/or stiff additive so as to form a shaped material incorporating the additive; and
v. removing at least a portion of the incorporated additive from the shaped material incorporating the additive, wherein the additive solidifies, hardens, and/or stiffens at a temperature of greater than 0° C.

2. The method of claim 1 wherein the plurality of interstices is a network of voids.

3. The method of claim 1 wherein the elastic or viscoelastic material is selected from: foams and/or sponges, felts, lattices, scaffolds, coiled materials, meshes, and/or webs.

4. The method of claim 1 wherein the elastic or viscoelastic material is a foam.

5. The method of claim 1 wherein the additive is selected from: a wax or wax-like compounds and mixtures thereof; a crystalline solid/supersaturated liquid; a liquid crystallising compound; a non-Newtonian compound that solidifies; granules/powders/other solids which can flow into the elastic or viscoelastic material; liquids and/or solids that can be hardened or could be arranged and oriented to be stiffer by other means.

6. The method of claim 1 wherein the additive is a wax or wax-like compound.

7. A shaped elastic or viscoelastic material having a plurality of interstices prepared by the method of claim 1.

8-9. (canceled)

10. A method of shaping an elastic or viscoelastic material having a plurality of interstices, the method including the steps of:
i. providing an elastic or viscoelastic material having a plurality of interstices;
ii. contacting the material with an additive so that at least a portion of the additive is incorporated within at least a portion of the plurality of interstices of the material;
iii. subjecting the material to conditions so that at least a portion of the incorporated additive solidifies, hardens, and/or stiffens;
iv. shaping the material incorporating the solid, hard, and/or stiff additive so as to form a shaped material incorporating the additive; and
v. removing at least a portion of the incorporated additive from the shaped material incorporating the additive,
wherein the additive is not water and the additive solidifies, hardens, and/or stiffens when subject to changes in conditions selected from: thermal, magnetic, electrical, chemical, and/or electromagnetic.

11. The method of claim 10 wherein the elastic or viscoelastic material is selected from: foams, felts, lattices, scaffolds, coiled materials, meshes, and/or webs.

12. The method of claim 11 wherein the elastic or viscoelastic material is a foam.

13. The method of claim 10 wherein the additive is selected from: a wax or wax-like compounds and mixtures thereof; a crystalline solid/supersaturated liquid; a liquid crystallising compound; a non-Newtonian compound that solidifies; granules/powders/other solids which can flow into the elastic or viscoelastic material; liquids that can be hardened or could be arranged and oriented to be stiffer by other means.

14. The method of claim 10 wherein the additive is a wax or wax-like compound.

15. A method of shaping an elastic or viscoelastic material having a plurality of interstices, the method including the steps of:
i. providing an elastic or viscoelastic material having a plurality of interstices;
ii. contacting the material with an additive so that at least a portion of the additive is incorporated within at least a portion of the plurality of interstices of the material;
iii. subjecting the material to conditions so that at least a portion of the incorporated additive solidifies, hardens, and/or stiffens;
iv. shaping the material incorporating the solid, hard, and/or stiff additive so as to form a shaped material incorporating the additive; and
v. removing at least a portion of the incorporated additive from the shaped material incorporating the additive,
wherein the additive solidifies, hardens, and/or stiffens when subject to changes in conditions selected from: magnetic, electrical, chemical, and/or electromagnetic.

16. The method of claim 15 wherein the plurality of interstices is a network of voids.

17-19. (canceled)

20. A method of forming a shaped elastic or viscoelastic material having a plurality of interstices, the method including the steps of:
i. in a vessel contacting an additive with a resin capable of being cured to form an elastic or viscoelastic material to form a mixture;
ii. degassing the mixture, such as by vacuum, and/or mixing the mixture to form a homogeneous blend;
iii. curing the resin so as to form an elastic or viscoelastic material incorporating at least some of the additive;
iv. shaping the material incorporating the additive so as to form a shaped material incorporating the additive; and
v. optionally removing at least a portion of the incorporated additive from the shaped material incorporating the additive,
wherein the additive is not water and the additive solidifies, hardens, and/or stiffens when subject to changes in conditions selected from: thermal, magnetic, electrical, chemical, and/or electromagnetic.

21. A shaped elastic or viscoelastic material having a plurality of interstices prepared by the method of claim 10.

22. A shaped elastic or viscoelastic material having a plurality of interstices prepared by the method of claim 15.

23. A shaped elastic or viscoelastic material having a plurality of interstices prepared by the method of claim 20.
